(19) United States
(12) Patent Application Publication
(10) Pub. No.: US 2004/0153968 A1
(43) Pub. Date: Aug. 5, 2004

(54) Method and system for user customizable asset metadata generation in a web-based asset management system

(76) Inventors: Jennie Ching, Northridge, CA (US); Andy G. Lean, West Hills, CA (US); Igor Mironenko, Northridge, CA (US)

Correspondence Address: DUANE MORRIS LLP, Suite 700, 1667 K Street, N.W., Washington, DC, 20006, US

(21) Appl. No.: 10/691,609

(22) Filed: Oct. 24, 2003

Related U.S. Application Data
(60) Provisional application No. 60/420,726, filed on Oct. 24, 2002.

(51) Int. Cl. G06F 17/21

(52) U.S. Cl. 715/513

(57) ABSTRACT

A method and system of providing easy configuration of asset metadata for each type of asset in a Web-based asset management is disclosed. The method and system comprises of one XML schema file for each asset type defined in the system, one XSL asset creation process stylesheet file that can be used with any XML schema file, one XSL asset metadata layout stylesheet for each asset type defined in the system, a Web-based application that uses the XML schema file and XSL asset creation process stylesheet file to display a form for the user to enter the metadata for a new asset, and to validate the data entry against the schema, and a XML database to store XML asset attribute files (one for each unique asset). Additionally, the method and system makes it possible for viewable files be linked to an asset metadata field with a unique XML asset attribute file, such as to facilitate previewing. The method and system further includes how metadata searching can be performed using the provided XML schema and XSL asset metadata layout stylesheets. Accordingly, a system and method in accordance with the present invention helps minimize development effort to handle custom asset metadata for different asset types and to allow different metadata fields to be searchable with various criteria for different asset types. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### CROSS REFERENCES

The present application is co-pending with and claims priority benefit of provisional application entitled “Method and System for User Customizable Asset Metadata Generation in a Web-Based Asset Management System”, Application S. No. 60/420,726 and filed on 24 Oct. 2002, the entirety of which is hereby incorporated herein by reference.

### FIELD OF INVENTION

The present invention relates generally to a system and method to ameliorate asset management by a web-based software application. More particularly, the present invention relates to web-based asset management and more particularly still to how asset metadata can be configured, managed, and displayed differently for distinct asset types for multiple customers, each with distinct business needs, in the same system.

### BACKGROUND OF THE INVENTION

It is not easy for an asset management system to support multiple asset types where each type of asset may have several custom attributes, e.g. metadata. Asset information and metadata may be typically stored in database tables that have to be created based on the metadata fields, field types, and the field lengths contained in the database tables.

Two methods exist for creating a table schema. In a first method, the table schema is created by database programmers based on input from end-users before the database is used by an application. In a second method, an application prompts a user to create the metadata fields, field types, and field length for each asset type and then builds each needed table programmatically. In general, the development process for creating such database tables is complex and time consuming. Moreover, once created, the tables are not particularly flexible.

A need exists for a web-based asset management system that provides a flexible way for multiple users to specify different metadata for different asset types and to be able to make use of those defined metadata fields in searching for assets of a certain type.

An Extensible Markup Language (XML) schema alone does not provide a way to ascertain whether metadata values that seem to be correct properly reflect the visual sense of a media object or asset. It is therefore also desirable to be able to visually preview the asset in order to validate the asset's metadata and help manage the asset.

### BRIEF DESCRIPTION OF THE DRAWINGS

FIG. 1 illustrates a block diagram of an asset management system in accordance with the present invention.

FIG. 2 illustrates an example of an XML schema file in which the asset metadata fields are defined for a specific asset type.

FIG. 3 illustrates an example of an XSL asset creation process stylesheet file.

FIG. 4 illustrates an example of an XSL asset metadata layout stylesheet file.

FIG. 5 illustrates an example of a XML asset attribute file created with metadata input from a user.

FIG. 6 illustrates an example of a graphical user interface (GUI) for an asset metadata input form (for a particular asset type) that was created by XLS transformation from the XML schema file and the XSL asset creation process stylesheet.

FIG. 7 illustrates an example of an asset metadata search form.

FIG. 8 illustrates an XML database collection structure.

FIG. 9 illustrates a block flow diagram of the asset creation process in accordance with the present invention.

FIG. 10 illustrates a block flow diagram of the asset search process in accordance with the present invention.

FIG. 11 illustrates an example of an asset metadata file with a viewable thumbnail image.

### DETAILED DESCRIPTION OF PREFERRED EMBODIMENTS

A method and system of providing configuration of asset metadata for each asset type is disclosed. In an embodiment, a web-based asset management system comprises an XML schema file for each asset type defined in the system, an XSL asset creation process stylesheet file that can be used with any XML schema file, an XSL asset metadata layout stylesheet for each asset type defined in the system, a web-based application that uses the XML schema file and XSL asset creation process stylesheet file to display a form for the user to enter the metadata for a new asset and to validate the data entry against the schema, and an XML database to store XML asset attribute files (one for each unique asset). As used herein, “web-based” is meant to comprise a system that can be accessed via a web browser, including those that make use of the Internet, intranet, extra-net, and similar data networks.

In an alternative embodiment, if an XML database server is not used, a dedicated file system may be used to house the XML schema files, the XSL asset creation process stylesheet, the XML asset metadata files, and the various other XML files used by the system.

The method and system further includes how metadata searching can be performed using the provided XML schema and XSL asset metadata layout stylesheets.

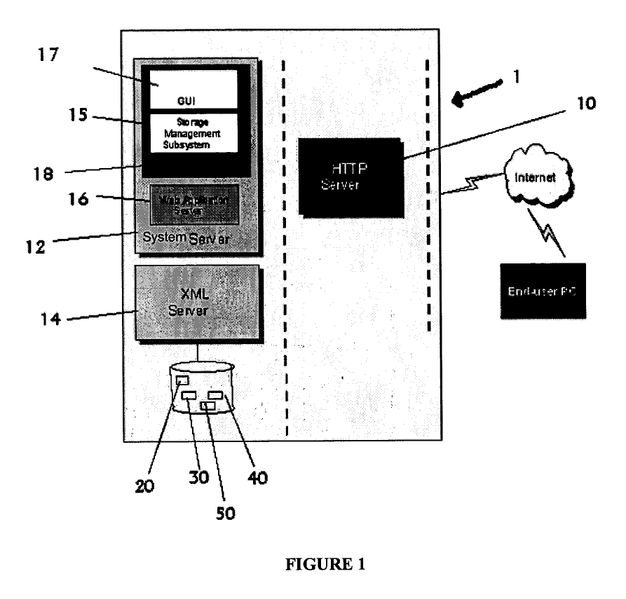

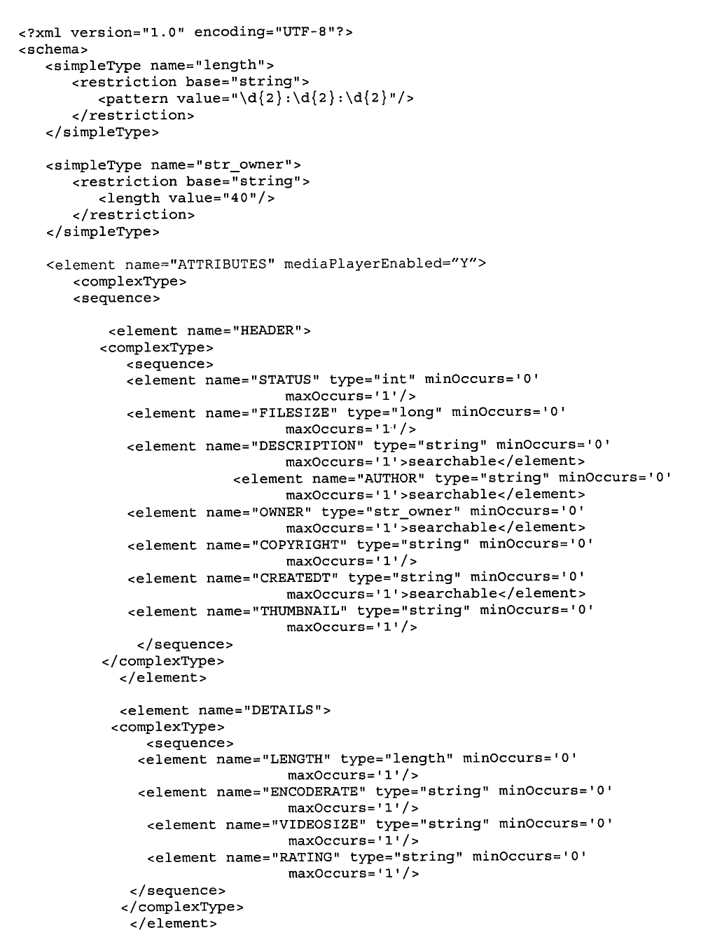

A block diagram of web-based application system 1 in accordance with the present invention is illustrated in FIG. 1. As shown, web-based application system 1 comprises HTTP server 10, System Server 12, and XML database server 14. System Server 12 may also include implementation of an application server, e.g. web application server 16.

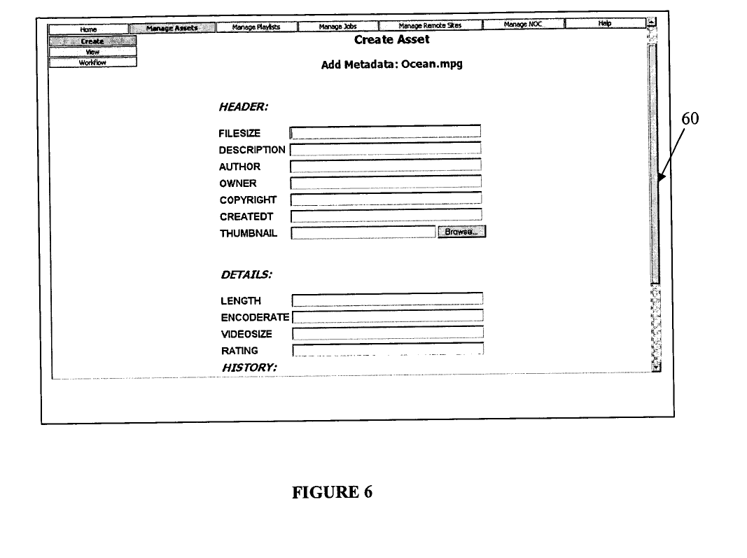

For each uniquely defined type of asset, web-based application system 1 may further comprise an asset metadata template for an asset type in XML schema file 20, where XML schema file 20 comprises a description of metadata fields and corresponding field type and field length for the asset type; XSL asset creation process stylesheet file 30 that can be used with XML schema file 20, XSL asset creation process stylesheet file 30 adapted to traverse XML schema file 20 and create a form displayed in a user interface based on a field specified in XML schema file 20, e.g. form 60 in FIG. 6; XSL asset metadata layout stylesheet 40 further comprising an XSL asset metadata display definition for an asset type in XSL asset metadata layout stylesheet 40; and web-based application 18 adapted to utilize asset metadata XML schema file 20 and XSL asset creation process stylesheet file 30 when performing an XSL transformation that displays an input form, e.g. form 60, for a user to enter asset metadata information. Additionally, XML asset attribute file 50 may exist for each unique asset.

XML database server 14 may be used to store XML schema files 20, XSL asset creation process stylesheet 30, and XSL asset metadata layout stylesheet files 40 as well as one or more XML asset attribute files 50 created with metadata input from one or more users.

In an embodiment, web-based application system 1 may further be adapted to utilize asset metadata XML Schema file 20 to display a form used to create an asset and validate the user input. Web-based application system 1 also allows a user to preview or otherwise manipulate the asset, if it has been defined as a previewable in XML schema file 20, such as via a browser which makes use of a media player.

As used herein, XSL transformation may further comprise display of a metadata field for defined assets of a specific asset type for user manipulation of stored metadata. Manipulation may comprise review or modification of data, or the like, or a combination thereof.

Web-based application system 1 may further be adapted to perform data validation on user data and store asset metadata into XML database 14. XML database 14 may comprise one collection per asset type per customer, one collection for a specific asset type for a given customer where the collection further comprises a list of asset metadata XML files, or the like, or a combination thereof.

Web-based application system 1 may further be adapted to utilize a searchable field defined in asset metadata XML schema 20 for a specific asset type to allow a user to search for assets based on the metadata defined in the XML schema for that asset type.

Web-based application 18 further comprises a graphical user interface (GUI) component, GUI 17, and storage management subsystem 15 to help process requests from users. In a preferred embodiment, web-based application 18 resides in system server 12. Web-based application 18 may utilize one or more configuration files, XML schema file 20 and XSL asset creation process stylesheet file 30, to display an input form, e.g., 60 in FIG. 6, to allow a user to enter asset metadata information using GUI 17.

Web-based application system 1 may further be adapted to utilize the asset metadata XML file and the asset metadata display XSL file to display XML asset attribute file 50 using GUI 17.

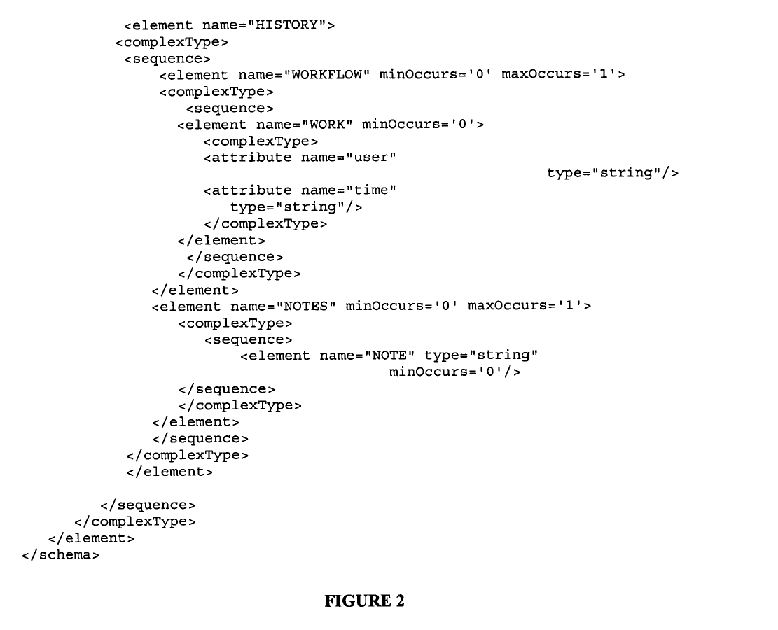

Referring additionally to FIG. 2, XML schema file 20 may be used to generate a HyperText Markup Language (“HTML”) data input form through XSL Transformation (XSLT) technology to accommodate specific user needs for asset metadata storage/repository. XML schema file 20 comprises a description of one or more metadata fields with a corresponding field type and field length for each asset type of a plurality of asset types. XML schema file 20 may further comprise a set of complex rules and enable parsing of XML Schema elements out through XSLT technology to properly generate user input fields for metadata.

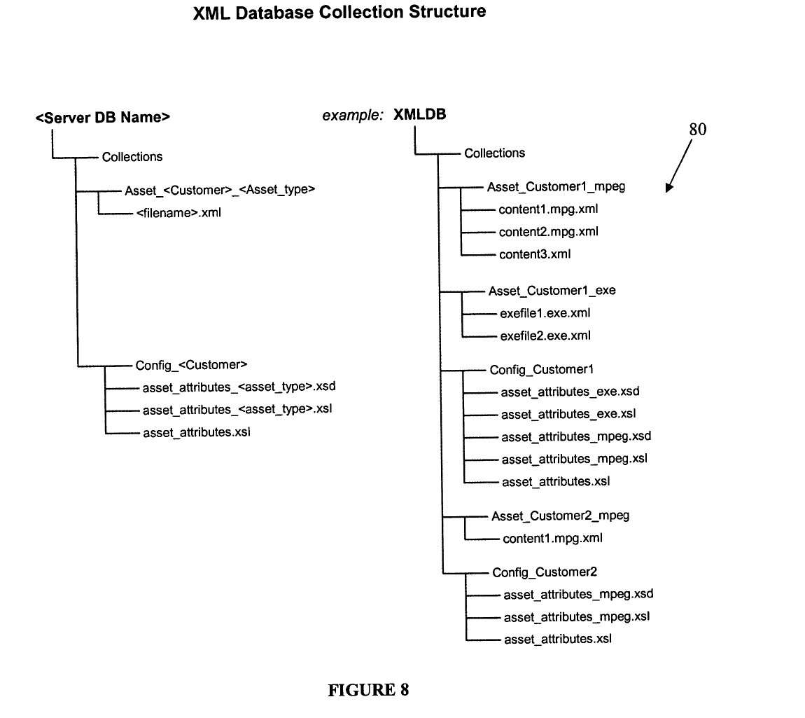

XML schema file 20 is a well-formed XML file that specifies metadata fields and the corresponding field type, e.g., integer, character, etc., as well as field length. As illustrated in FIG. 2, XML schema file 20 comprises one or more asset metadata fields which may be defined for a specific asset type. In a preferred embodiment, XML schema file 20 further conforms to a file naming convention, e.g. asset_attributes_<asset_type>.xsd, where <asset_type> can be “mpg,” “jpg,” “exe,” or any file type that uniquely defines the metadata attributes associated with that asset type, e.g. such as for a given customer, as illustrated in FIG. 8.

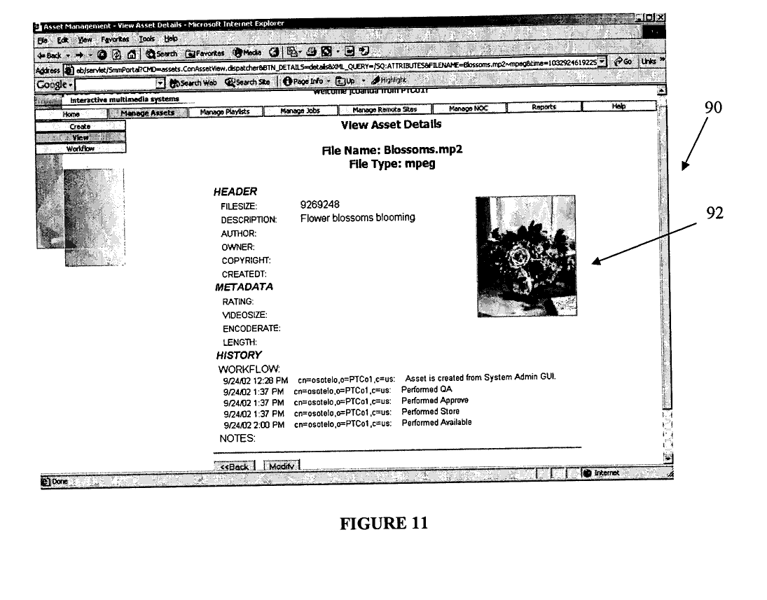

XML schema file 20 may further comprise a specifier to signify whether a field is optional or searchable or both, whether an asset can be handled by a media player such as those that may be launched through a web browser, or the like, or a combination thereof. For example, a field may be designated as optional by specifying a specific value such as “minOccurs” and “maxOccurs” and/or defined as searchable. A field may also be specified as allowing a link, e.g. a universal resource location (URL), to a manipulatable file such as a viewable jpeg file. This may be useful in providing preview or “thumbnail” image 92 (as illustrated in detail form 90 in FIG. 11). Additionally, other fields may be included, e.g. a field that specifies if a file type can be handled or otherwise manipulated, e.g. played, by a media player via a browser. XML schema file 20 may comprise a description of metadata fields and corresponding field type and field length for each asset type of a plurality of asset types. There may be one or more XML schema files, e.g. a plurality may be present where each XML schema file is associatable with a specified asset type, e.g. for a specific customer.

If XML database 14 is present, XML schema file 20 may be stored in XML database 14 such as in a collection, as illustrated in FIG. 8 as Config_<Customer>.

Web-based application 18, in conjunction with an XSLT processor, may use XML schema 20 to display in the GUI 17 the asset metadata creation form 30. Web-based application 18 and the processor use the XSLT stylesheet, matching templates to nodes and performing a tree-to-tree transformation that results in a “result tree.” If the transformation converts an XML document into HTML, the result tree may contain a tree of HTML elements that may be sent to a browser.

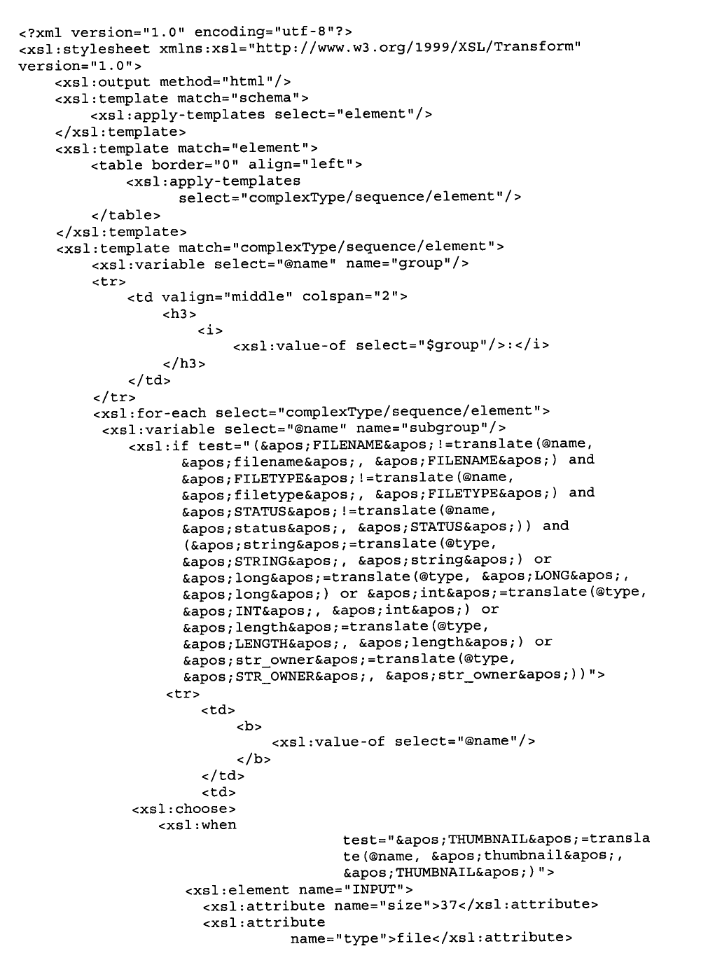

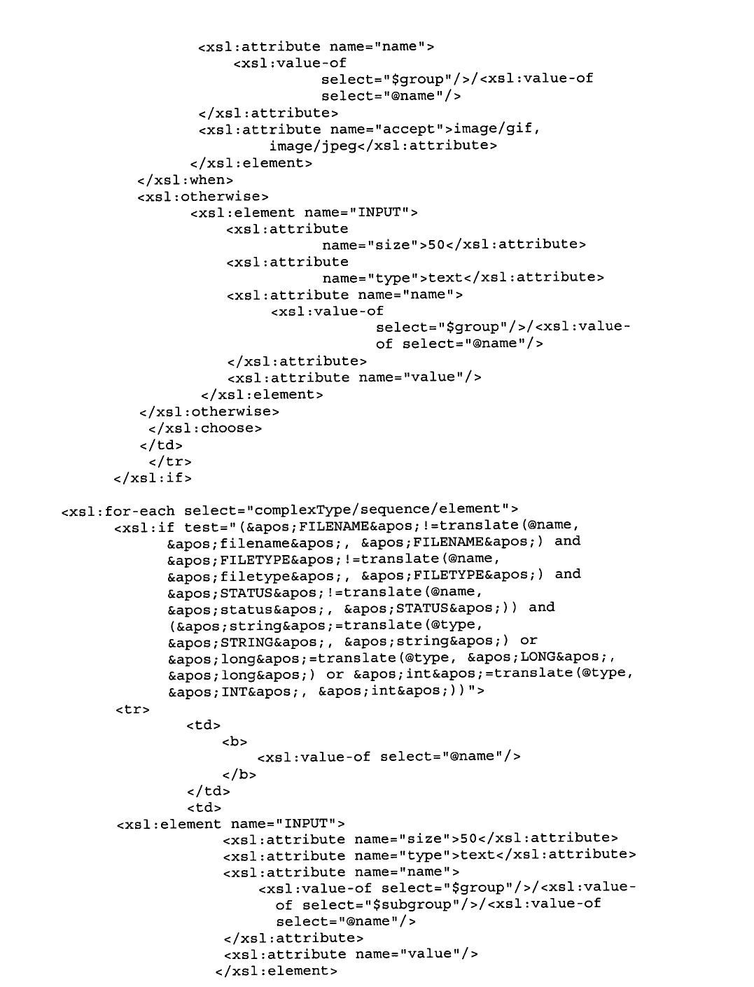

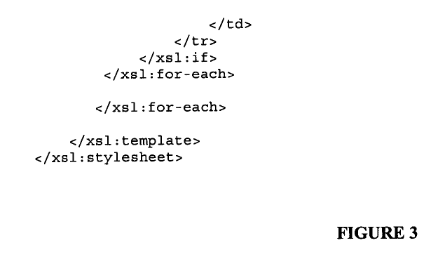

Referring now to FIG. 3, XSL asset creation process stylesheet 30 is a well-formed XML file that a user interface such as GUI 17 in FIG. 1 may utilize to traverse through XML schema file 20 (FIG. 1) to create a form for an initial definition of an asset based on the fields specified in XML schema file 20, e.g. form 60 in FIG. 6. XSL asset creation process stylesheet 30 comprises layout information used for configuration of the display form for the initial definition of a new asset for a specified asset type.

XSL asset creation process stylesheet 30 may therefore be adapted to aid with configuration of the display for the initial definition of a new asset within web-based application system 1. XSL asset creation process stylesheet 30 may be named according to a convention, e.g. asset_attributes.xsl, as illustrated in FIG. 8.

XSL asset creation process stylesheet 30 can be used with XML schema files 20 (FIG. 1) that have been defined in web-based application system 1, and, if XML database 14 (FIG. 1) is used, may also be stored in XML database 14, e.g. in a named collection such as Config_<Customer> illustrated in FIG. 8.

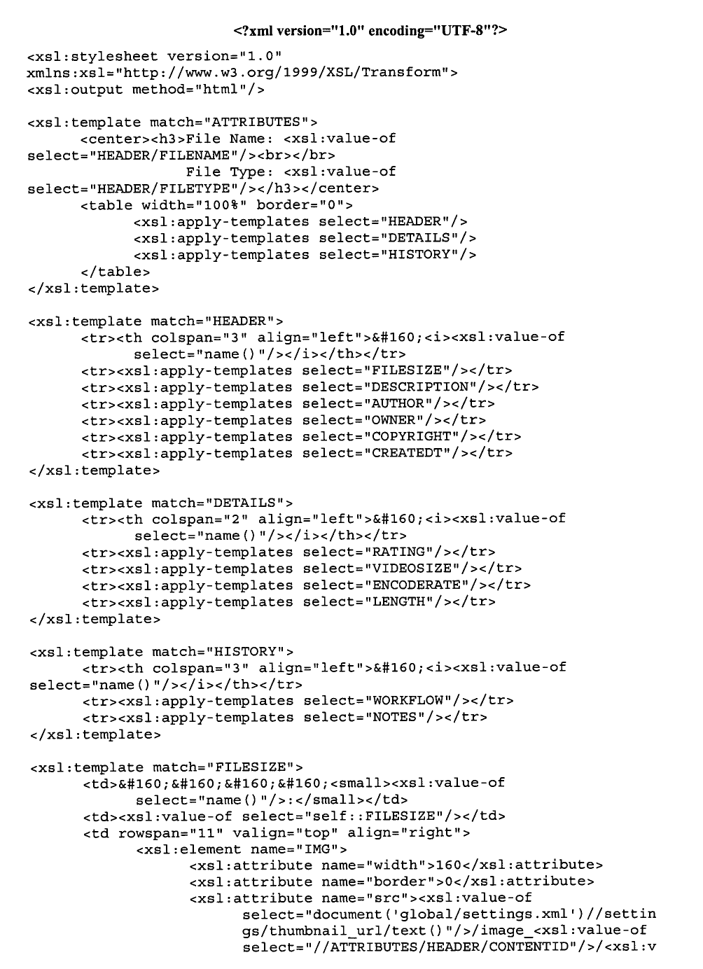

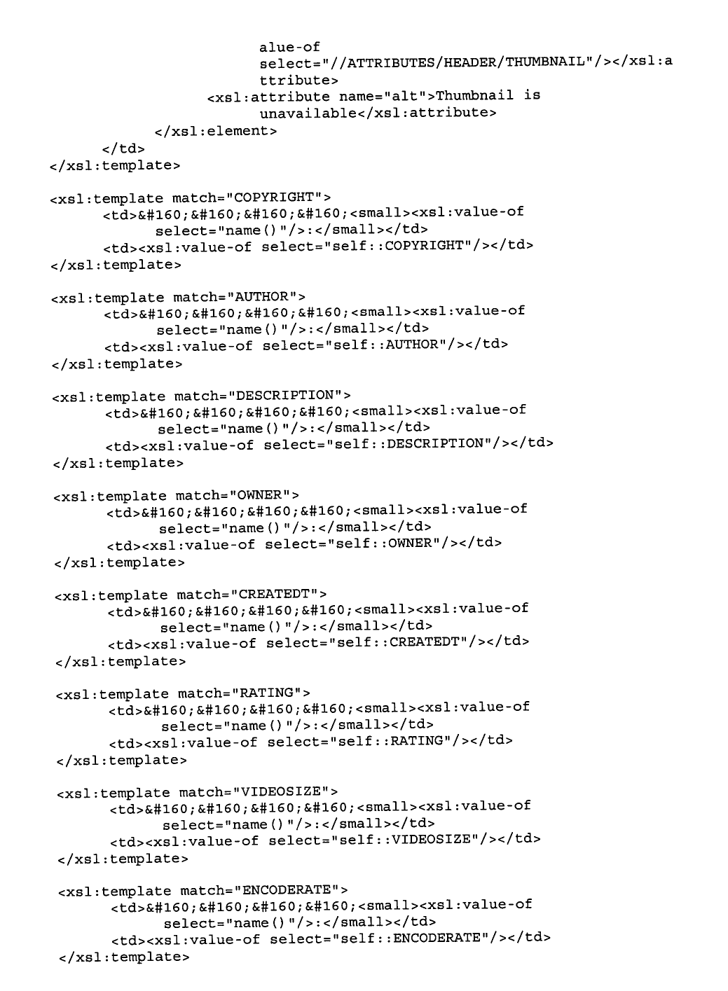

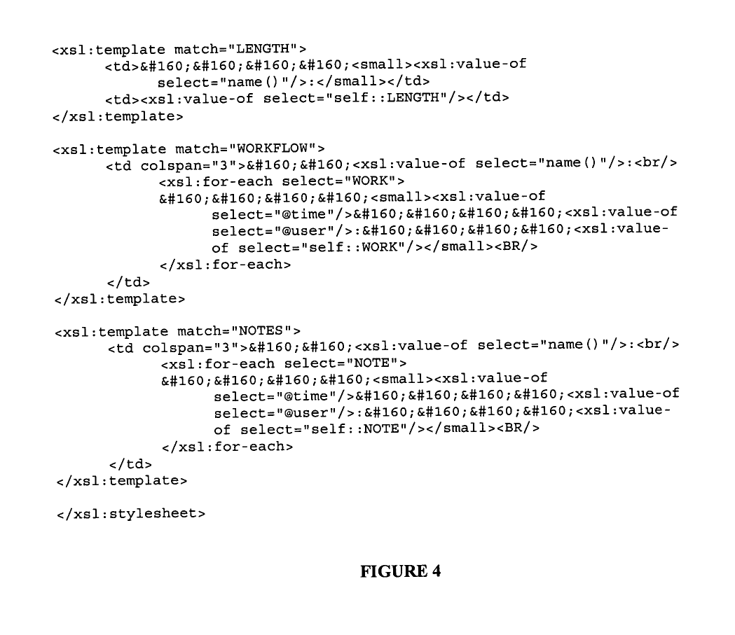

Referring now to FIG. 4, XSL asset metadata layout stylesheet 40 may be used to describe how the metadata for assets of a specific asset type should be displayed. XSL asset metadata layout stylesheet 40 may conform to the file naming convention as illustrated in FIG. 8, e.g. asset_attributes_<asset type>.xsl.

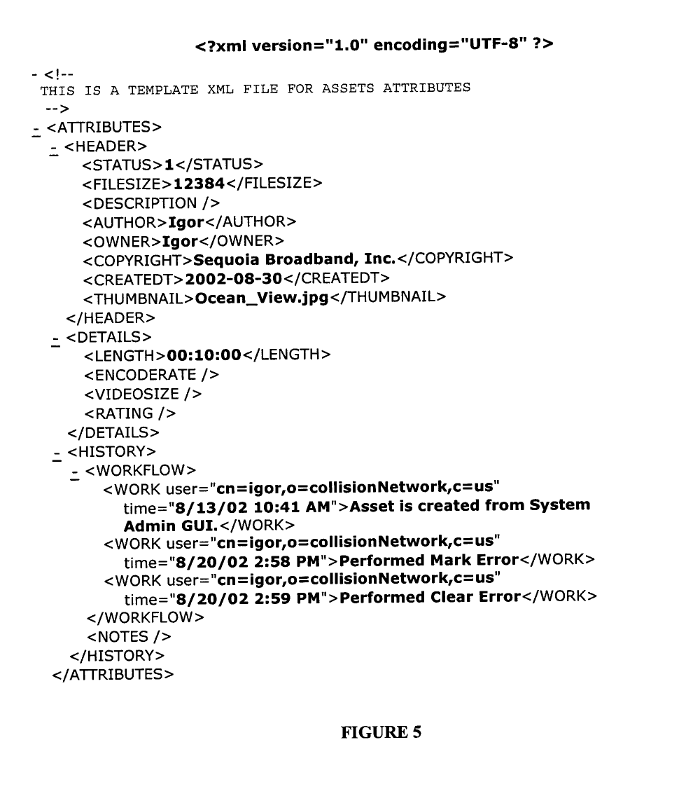

Referring now to FIG. 5, a user created asset metadata file, XML asset attribute file 50, may comprise data a user enters via GUI 17 about a particular asset, such as the copyright owner, date created, rating, or other information, for all fields defined in the XML schema file which a particular customer wants to track for assets of that type. Additionally, a unique XML asset attribute file 50 may exist for each unique asset. In a preferred embodiment, a unique XML asset attribute file 50 will exist for each unique asset. Each XML asset attribute file 50 will contain metadata uniquely associated with each individual asset. XML asset attribute file 50 may conform to the file naming convention as illustrated in FIG. 8, e.g. <filename>.xml.

Referring now to FIG. 6, GUI 17 may comprise a tabular or other display that allows a user to input data needed to operate web-based application system 1. In such an environment, form 60 may be created dynamically by a transform governed by XML schema file 20 (FIG. 2) and data in XSL asset creation process stylesheet 30 (FIG. 3).

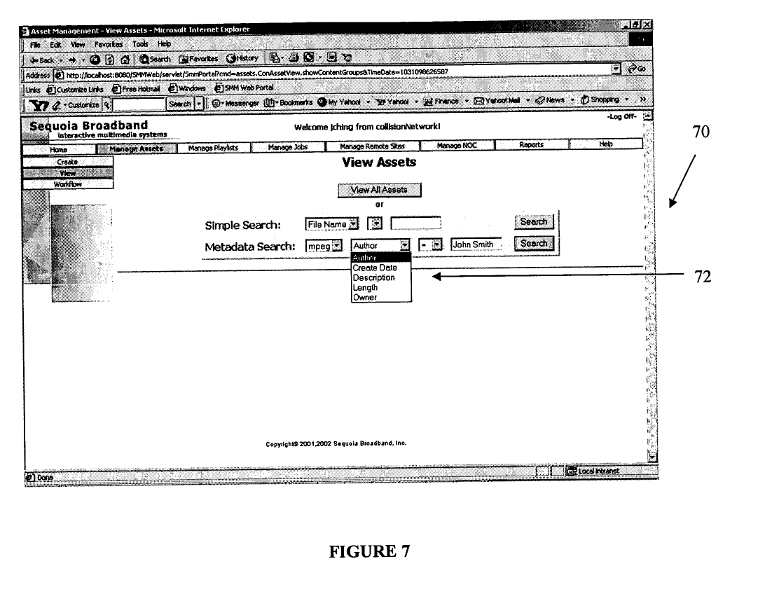

Referring now to FIG. 7, additional displays of GUI 17 may be used to aid in searching assets via web-based application system 1, e.g. via search form 70.

Referring now to FIG. 8, an exemplary XML Database Collection Structure is illustrated.

In the operation of an exemplary embodiment, a user, through use of web-based application system 1, may make a request to web-based application 18 (FIG. 1) to create a new asset, i.e., define a unique file in web-based application system 1 for that asset with associated metadata, or to modify an existing asset's metadata.

An asset metadata file usable by a web-based asset management application may be defined by providing an asset metadata template for an asset type in XML schema file, 20 (FIG. 1); providing XSL asset creation process stylesheet file 30 (FIG. 1) that can be used with XML schema file 20 where XSL asset creation process stylesheet file 30 is adapted to traverse XML schema file 20 and create a form, e.g. form 60 (FIG. 6) displayed in user interface GUI 17 (FIG. 1), based on one or more fields specified in XML schema file 20; and providing XSL asset metadata layout stylesheet 40 which may further comprise asset metadata display definition for defined (i.e., already created) assets of a specified asset type.

Web-based application 18 may be adapted to utilize asset metadata XML Schema file 20 to access the asset, e.g. via a browser. For those assets marked as previewable, accessing the previewable asset may comprise viewing the asset at a display, e.g. using the browser, hearing the asset using the browser where the browser further launches a media player or other helper application in response to the access, or the like, or a combination thereof.

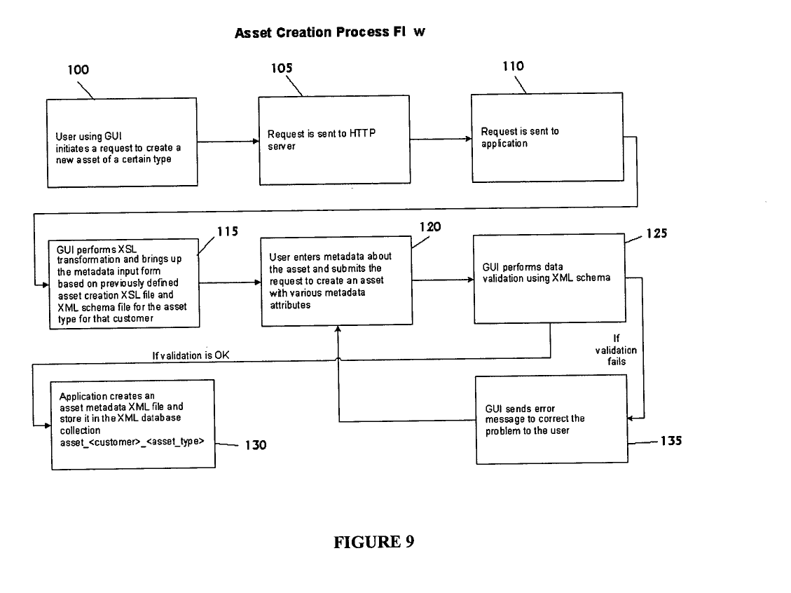

Referring now to FIG. 9, when a user makes a request to define a new asset, e.g. through GUI 17 (FIG. 1) (step 100), HTTP server 10 (FIG. 1) forwards the request to web-based application 18 (FIG. 1) (steps 105, 110). The user may select from a list of asset types that have been defined for that customer such as may be presented on a form in GUI 17. Once the user selects the asset type, GUI 17 retrieves a previously defined asset metadata XML schema file 20 (FIG. 2) for that asset type and XSL asset creation process stylesheet 30 (FIG. 3) from an appropriate source, e.g. XML database 14 (FIG. 1), and performs an XSL transformation (step 115) using those files to bring up the metadata input form for that asset type to be presented via GUI 17. An example of such an input form, form 60, is illustrated in FIG. 6.

Once a user enters metadata and submits a request for the metadata to be processed, (step 120), a process such as GUI 17 (FIG. 1) may perform data validation against each field type and field length as defined in XML schema file 20 for that asset type (step 125). If the metadata validation is successful, web-based application 18 (FIG. 1) combines the user-entered metadata along with XML metadata schema file 20 to create an asset metadata XML file which may be stored in XML database 14, e.g. in a collection named Asset_<Customer>_<asset_type> for that customer (step 130). If the metadata validation is unsuccessful, an error message may be displayed to inform the user who may then be prompted or otherwise allowed to correct the mistake (step 135) and resubmit a corrected request.

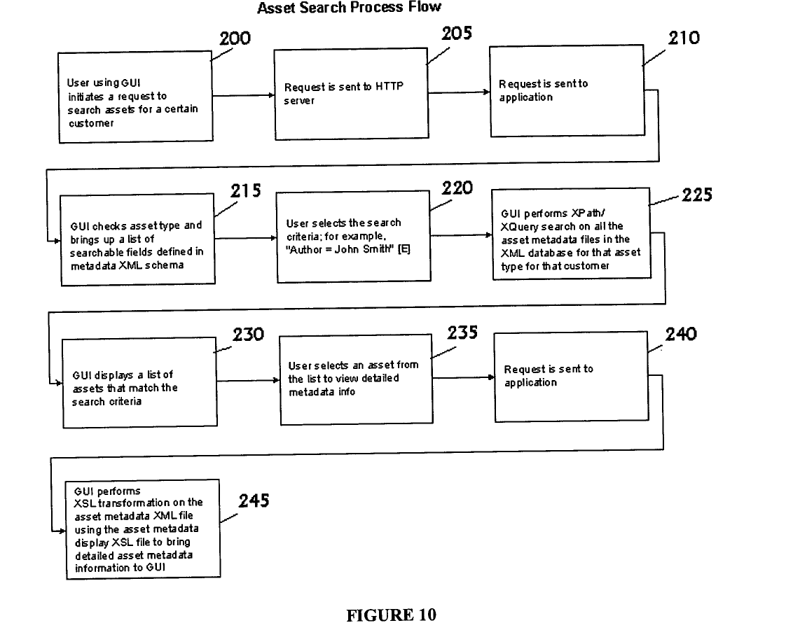

Referring now to FIG. 10, a user's search for assets may be enhanced based on easily configured searchable metadata fields. When a user makes a request to web-based application 18 to search for assets based on metadata fields, (step 200), the request may be presented to HTTP server 10 (step 205) and then forwarded to web-based application 18 (step 210). To begin the searching process, the user may first select an asset type, e.g. using GUI 17. Once the user selects the asset type, GUI 17 may present the user with a list of searchable fields (step 215) as defined in the metadata of XML schema 20 (FIG. 2) for that asset type. The user may then select one or more search criteria (illustrated in form 70 in FIG. 7) such as via GUI 17 and submit a search request (step 220). GUI 17 may be used to perform an XPath/XQuery search (step 225) on all the asset metadata XML files in a collection of XML database 14 for that asset type for a particular customer, and then create a list of assets that match the search criteria.

GUI 17 (FIG. 1) may further perform an XSL transformation on the asset metadata XML using XSL asset metadata layout stylesheet file 30 (FIG. 4) to list the assets that meet the search criteria (step 230), thus enabling the user to then select any one of the listed assets (step 235) to bring up all the detailed asset metadata information (steps 240, 245) that had previously been saved. This may include a link to a viewable file which is then displayed in a pre-defined area of GUI 17 accordingly along with the other metadata fields, e.g. shown at 90,92 in FIG. 11. XSL asset metadata layout stylesheet file 30 (FIG. 4) may be used to display this information.

The present invention comprises a novel use of template design for use in creation of an asset, displaying metadata about an asset, and, where possible, viewing the asset itself. The method described herein uses metadata validation tasks in an environment that needs to be flexible to be able to utilize different metadata for each of many different types of assets. In an embodiment, the novel use of the single template design for metadata creation for each unique asset type in the system is described that allows specifying XML metadata in an adaptive way during the metadata creation and validation process.

Further, a novel use of visual preview with a single metadata template for creating assets for a unique asset type has been devised that greatly enhances the metadata creation and validation tasks, such as those enabled in an asset management system that allows extensive metadata descriptions to be associated to various types of assets.

In an aspect of the invention, it is possible to link a viewable file to a unique XML asset in order to facilitate previewing the asset to ensure that, in fact, the metadata (e.g., length) properly describes the asset.

The present invention utilizes XML, XML schema, XSL, and XSL transformation to address such needs. A XML database may be used with the present invention. Alternatively, a dedicated file system that contains the necessary XML configuration files can be used. However, XML by itself is not meant to be a mechanism to provide a fully asset independent platform for customizing the metadata. The use of a single and adaptive metadata template has been devised in order to support fully customizable metadata in an asset management system. A single metadata template for each type of asset description is a novel feature for this asset management system.

One aspect of the invention is that a metadata template and its method of use allow a user to define many different kinds of things they like to know about assets of that type in their system. No matter what they put in the metadata template in order to help manage assets, the underpinning system does not need to change.

It will be understood that various changes in the details, materials, and arrangements of the parts which have been described and illustrated above in order to explain the nature of this invention may be made by those skilled in the art without departing from the principle and scope of the invention as recited in the appended claims.

What is claimed is:

1. A method of defining a customizable asset metadata file usable by a web-based asset management application, comprising:
a. providing an asset metadata template for an asset type in an Extensible Markup Language (“XML”) schema file, the XML schema file comprising a description of metadata fields and corresponding field type and field length for the asset type;
b. providing an XSL asset creation process stylesheet file that can be used with an XML schema file, the XSL asset creation process stylesheet file adapted to traverse the XML schema file and create a form displayed in a user interface based on a field specified in the XML schema file; and
c. providing an XSL asset metadata layout stylesheet, the XSL asset metadata layout stylesheet further comprising an XSL asset metadata display definition for an asset type in the XSL asset metadata layout stylesheet.

2. The method of claim 1, wherein the XML schema file further comprises a specifier to signify at least one of (a) whether a field is optional or searchable or both or (b) whether an asset can be handled by a media player through the browser.

3. The method of claim 1, wherein the XML schema file comprises a description of metadata fields and corresponding field type and field length for each asset type of a plurality of asset types.

4. The method of claim 1, wherein providing the XML schema file further comprises providing a plurality of XML schema files.

5. The method of claim 4, wherein each XML schema file is associatable with a specified asset type.

6. The method of claim 1, wherein the XSL asset metadata layout stylesheet comprises layout information useful for displaying metadata for a specified asset type.

7. The method of claim 6, wherein the layout information further comprises a designator indicative of which fields should be displayed to a user that is creating a new asset or modifying an existing asset's metadata.

8. A web-based asset management system, comprising:
a. an asset metadata template for an asset type in an XML schema file, the XML schema file comprising a description of metadata fields and corresponding field type and field length for the asset type;
b. an XSL asset creation process stylesheet file that can be used with an XML schema file, the XSL asset creation process stylesheet file adapted to traverse the XML schema file and create a form displayed in a user interface based on a field specified in the XML schema file;
c. an XSL asset metadata layout stylesheet, the XSL asset metadata layout stylesheet further comprising an XSL asset metadata display definition for an asset type in the XSL asset metadata layout stylesheet; and
d. a web-based application adapted to utilize the asset metadata XML schema file and the XSL asset creation process stylesheet file when performing an XSL transformation that displays an input form for a user to enter asset metadata information.

9. The web-based asset management system of claim 8, wherein the XML schema file comprises a description of metadata fields and corresponding field type and field length for each asset type of a plurality of asset types.

10. The web-based asset management system of claim 8, wherein the XSL transformation further comprises display of a metadata field for defined assets of a specific asset type for user manipulation of stored metadata.

11. The web-based asset management system of claim 9, wherein the manipulation comprises at least one of (a) review or (b) modification.

12. The web-based asset management system of claim 8, the Web-based application is further adapted to:
a. perform data validation on user data; and
b. store asset metadata into the XML database.

13. The web-based asset management system of claim 8, wherein the XML database comprises at least one of (a) one collection per asset type per customer or (b) one collection for a specific asset type for a given customer, the collection further comprising a list of asset metadata XML files.

14. The web-based asset management system of claim 8, wherein the web-based application is further adapted to utilize a searchable field defined in the asset metadata XML schema for a specific asset type to allow a user to search for assets based on the metadata defined in the XML schema for that asset type.

15. The web-based asset management system of claim 8, wherein the web-based asset application is further adapted to utilize the asset metadata XML file and the associated asset metadata display XSL file for that asset type to display the asset's metadata in a graphical user interface (GUI).

16. The web-based asset management system of claim 8, wherein the web-based application is further adapted to utilize the asset metadata XML Schema file to access the asset.

17. The web-based asset management system of claim 16, wherein, for assets that are previewable, access is at least one of (a) viewing the asset at a display using the browser or (b) hearing the asset using the browser that further launches a media player or other helper application in response to the access.
